(19) United States
(12) Patent Application Publication
(10) Pub. No.: US 2026/0365157 A1
(43) Pub. Date: Nov. 19, 2026

(54) TERRAIN-BASED LOAD ANTICIPATION AND SPEED CONTROL OF A MOBILE AGRICULTURAL MACHINE

(71) Applicant: Deere & Company, Moline, IL (US)

(72) Inventors: Joseph P. BOYER, Cedar Falls, IA (US); Daniel M. SOLANO, Monterrey (MX); Shane M. BODEN, Vinton, IA (US)

(21) Appl. No.: 19/212,223

(22) Filed: May 19, 2025

(51) Int. Cl. B60W 30/04; B60W 10/10

(52) U.S. Cl. CPC B60W 30/04; B60W 10/10; B60W 2030/041; B60W 2300/152; B60W 2510/0638; B60W 2510/0657; B60W 2510/0666; B60W 2520/10; B60W 2520/16; B60W 2556/50

(57) ABSTRACT

A terrain-based control system anticipates load changes on a mobile agricultural machine by identifying upcoming changes in pitch along a route being traveled by the mobile agricultural machine. The terrain-based control system then generates an adjustment value to adjust load accommodation functionality such as an engine speed or a gear ratio to maintain a desired ground speed.

### FIELD OF THE DESCRIPTION

The present description relates to mobile agricultural machines. More specifically, the present description relates to terrain-based load anticipation for controlling ground speed and job quality of a mobile agricultural machine.

### BACKGROUND

There is a wide variety of different types of mobile agricultural machines. Some such agricultural machines include tractors, sprayers, tillage machines, air seeders, planters, harvesters, among others.

Such mobile agricultural machines often perform agricultural operations in fields that have hilly terrain. In traversing the terrain, the mobile agricultural machines thus travel over terrain which changes the orientation of the agricultural machine. For instance, as a mobile agricultural machine is traversing a field, the mobile agricultural machine may change pitch multiple times during a single pass.

The discussion above background is merely provided for general background information and is not intended to be used as an aid in determining the scope of the claimed subject matter.

### SUMMARY

A terrain-based control system anticipates load changes on a mobile agricultural machine by identifying upcoming changes in pitch along a route being traveled by the mobile agricultural machine. The terrain-based control system then generates an adjustment value to adjust load accommodation functionality such as an engine speed or a gear ratio based on a desired ground speed.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1A is a side view of an agricultural system with one example of a mobile agricultural machine in the form of a tractor towing a planting machine, shown in a partial pictorial and partial schematic form.

FIG. 1B is a top view of an agricultural system with two examples of a mobile agricultural machine, one in the form of a harvester, and another in the form of a tractor pulling a grain cart.

FIG. 1C is a top view showing another example of a mobile agricultural machine in the form of a tractor pulling a tillage implement.

FIG. 2 is a block diagram of one example of an agricultural system.

FIG. 3 is a block diagram showing one example of a terrain-based load anticipation control system in more detail.

FIGS. 4A and 4B (collectively referred to herein as FIG. 4) show a flow diagram illustrating one example of the operation of an agricultural system.

FIG. 5 shows a flow diagram illustrating one example of the operation of a pitch change threshold processing system.

FIG. 6 shows a flow diagram illustrating one example of the operation of a load processing system.

FIG. 7 is a block diagram showing one example of a mobile agricultural machine communicating with items in a remote server architecture.

FIGS. 8, 9, and 10 show examples of mobile devices that can be used in the architectures and systems shown in other FIGS.

FIG. 11 is a block diagram showing one example of a computing environment that can be used in the architectures and systems shown in other FIGS.

### DETAILED DESCRIPTION

For the purposes of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example may be combined with the features, components, and/or steps described with respect to other examples of the present disclosure.

As discussed above, there are many types of mobile agricultural machines. Some current mobile agricultural machines, such as some current tractors, can operate in an automatic mode in which an operator sets a desired ground speed, and an automated control system controls the mobile agricultural machine to operate at that speed. For instance, one current automated control system automatically shifts gears and changes engine speed under different load conditions to maintain a desired ground speed. Also, some current tractors have a load anticipation feature in which the automated control system anticipates or estimates upcoming changes in power requirements and adjusts engine speed and a transmission gear ratio based upon the anticipated power requirements. However, the current load anticipation feature is only triggered by criteria detected on the tractor itself, such as engaging a power take off or changing the position of a selective control valve.

This can lead to undesirable operation. For instance, there may be sudden changes in pitch of the mobile agricultural machine induced by uneven terrain. Current automated control systems do not react quickly enough to the changes in load on the mobile agricultural machine caused by such changes in pitch, resulting in significant wheel speed group and/or engine stalls. This can lead to inefficiencies in the agricultural operation being performed, as well as to significant reductions in job quality. Also, shifting after encountering an increase in load can lead to significant operator discomfort.

For example, there are many agricultural operations in which maintaining a desired ground speed is an important factor when attempting to achieve a desired job quality. One such agricultural operation is applying a commodity, such as fertilizer, insecticides, pesticides, herbicides, or another commodity to a field. The ground speed at which the material application machine travels is often controlled by an operator. Frequent changes in ground speed or engine stalls can lead to suboptimal performance in applying the material.

Another agricultural operation where maintaining a desired ground speed is important can be an operation in which multiple mobile agricultural machines are operating in conjunction with one another. One such operation is where a tractor is pulling a grain cart and receiving harvested material from an agricultural harvester, as the agricultural harvester is traveling through the field. In such an operation, it is important for the two vehicles to maintain a desired ground speed to avoid a misalignment between the harvester spout and the grain cart. Even a momentary misalignment can result in hundreds of pounds of harvested material being dumped on the ground instead of in the grain cart.

Yet another example of an agricultural operation where maintaining a desired ground speed is important can be a harvesting operation. For instance, harvesters may perform differently based upon the amount of material being engaged by the harvester at any given time. In some cases, it can be desirable to engage a relatively constant amount of material as the harvester is traversing the field. Thus, frequent changes in wheel speed and/or engine stalls induced by uneven terrain can lead to suboptimal harvester performance.

Also, it is not uncommon for harvesters to operate at engine speeds that yield peak engine power. Thus, it can be difficult to maintain ground speed under increased load conditions, such as when going up a hill. Therefore, in such circumstances, it may be more beneficial to anticipate an increase in load (based on an increase in pitch, for instance) and reduce ground speed so peak power can continue to be provided to drive the other functionality on the harvester.

In yet another example, air seeders often use hydraulically powered fans or blowers to propel seed through delivery conduits to the seeding tool. When an air seeder encounters a hill, the increased load can cause the engine speed to drop suddenly and significantly, which can reduce hydraulic flow and thus slow the fan speed. When the fan speed drops below a threshold speed, this can lead to blockage in the delivery conduits. The machine then often needs to be shut down so the delivery conduits can be cleared.

These are just some examples of agricultural operations where maintaining a desired ground speed can be important. There are others as well.

The present description thus proceeds with respect to a mobile agricultural machine that has a terrain-based load anticipation control system. The terrain-based load anticipation control system automatically identifies a route of a mobile agricultural machine and looks ahead, along that route, to identify changes in pitch that will be encountered by the mobile agricultural machine. The system then automatically determines whether an adjustment needs to be made to load accommodation functionality (such as the gear ratio in a gear transmission and/or engine speed) to maintain a desired ground speed and/or to maintain a desired job quality. If so, the system automatically generates the adjustment value which can be applied to the gear transmission and/or to the engine to change the gear ratio and/or engine speed as desired. The gear transmission can include, but is not limited to, transmissions having one or more gear sets providing a finite or distinct number of gear ratios, or transmissions having a combination of one or more gear sets providing a finite or distinct number of gear ratios and a variator providing continuously variable gear ratios.

It will be noted that the present description proceeds with respect to a mobile agricultural machine that may be a tractor, that is being used to perform a variety of different agricultural operations, or a harvester. However, these are examples only and the present description could just as easily be applied to other mobile agricultural machines that have transmissions with continuously variable gear ratios and engines with variable engine speeds.

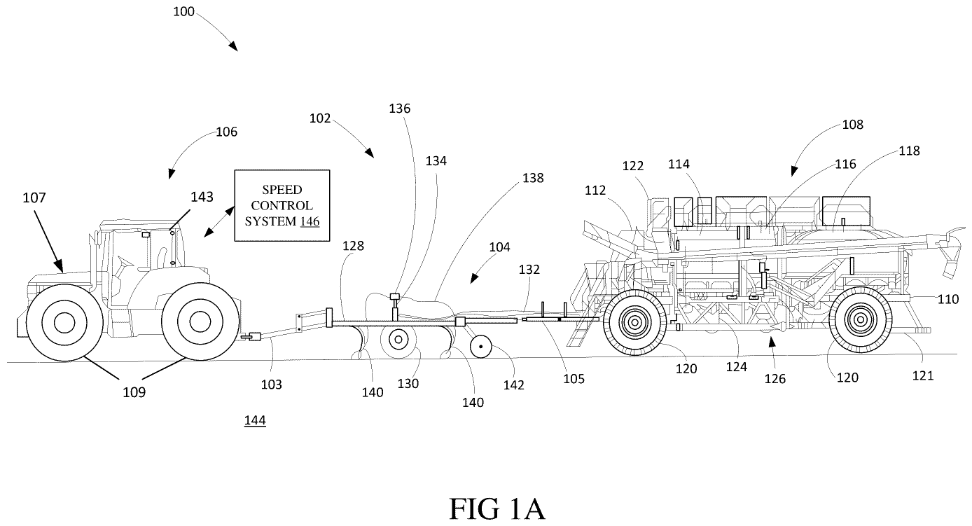

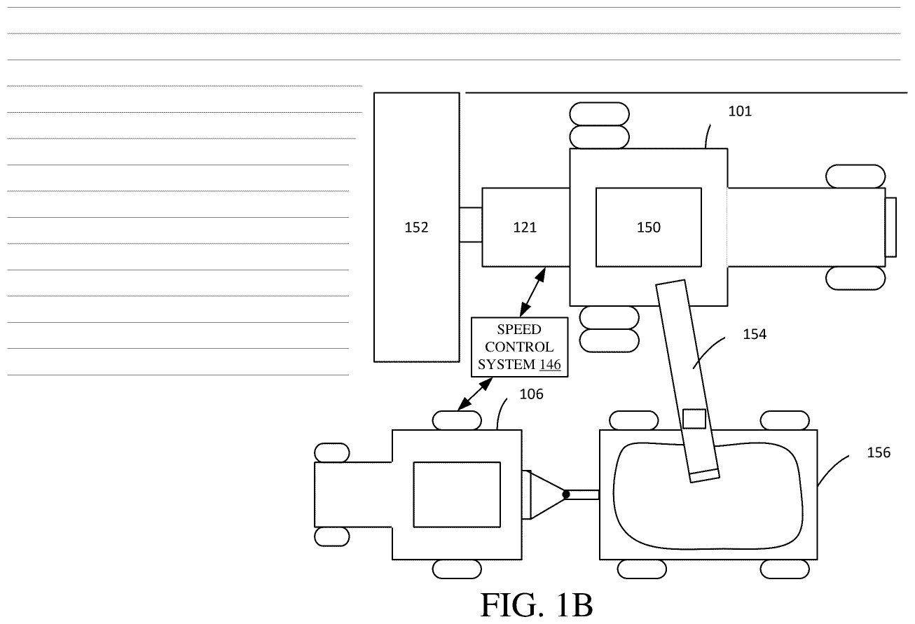

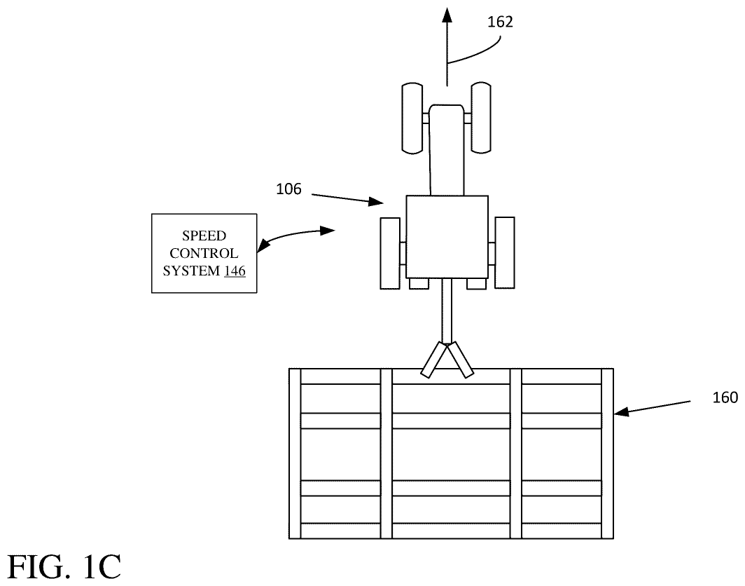

FIG. 1A is a side view of one example of an agricultural system 100 which includes a mobile agricultural machine in the form of a tractor 106 that is pulling an agricultural implement, in particular an air seeder or pneumatic seeder 102. In the example shown in FIG. 1A, tractor 106 has an operator compartment 143, a gear transmission that is driven by a variable speed engine, such as an internal combustion engine, that is housed in engine compartment 107. The gear transmission can be used to drive one or more ground engaging elements, such as wheels 109 (or tracks). The seeder 102 comprises a tilling implement (also referred to as a material application implement or drill or seeding tool) 104 towed between tractor 106 and a commodity cart (also sometimes called an air cart) 108. The commodity cart 108 has a frame 110 upon which a series of product tanks 112, 114, 116, and 118, and wheels 120 are mounted. There may be one or more tanks, and four tanks are shown in FIG. 1A as an example only. Each product tank has a door (a representative door 122 is labeled) releasably sealing an opening at the upper end of the tank for filling the tank with product, most usually seed or a commodity of one type or another. A dispensing system 124 is provided at a lower end of each tank (a representative one of which is labeled in FIG. 1A) for controlled feeding or draining of product (most typically granular material) into a pneumatic distribution system or delivery system 126. The tanks 112, 114, 116, and 118 can hold, for example, a material or commodity such as seed or fertilizer to be distributed to the soil. The tanks can be hoppers, bins, boxes, containers, etc. Furthermore, one tank with multiple compartments can also be provided instead of separate tanks.

The seeding tool 104 includes a frame 128 supported by ground engaging wheels 130. Frame 128 is connected to a leading portion of the commodity cart 108, for example by a tongue style attachment (not labeled). The commodity cart 108 as shown is sometimes called a “tow behind cart,” meaning that the cart 108 follows the seeding tool 104. In an alternative arrangement, cart 108 can be configured as a “tow between cart,” meaning the cart 108 is between the tractor 106 and seeding tool 104. In yet a further possible arrangement, the commodity cart 108 and seeding tool 104 can be combined to form a unified rather than separated configuration. These are just examples of additional possible configurations. Other configurations are even possible, and all configurations should be considered contemplated and within the scope of the present description.

In the example shown in FIG. 1A, tractor 106 is coupled by couplings 103 to seeding tool 104 which is coupled by couplings 105 to commodity cart 108. The couplings 103 and 105 can be mechanical, hydraulic, pneumatic, and electrical couplings, and/or other couplings. The couplings 103 and 105 can include wired and wireless couplings as well.

The pneumatic distribution system 126 includes one or more fans or blowers located generally at 121 connected to a product delivery conduit structure having multiple product flow passages referred to as primary delivery tubes 132. The fan directs air through the primary delivery tubes 132. Each product dispensing system 124 controls delivery of product from its associated tank at a controllable rate to the transporting airstreams moving through primary delivery tubes 132. In this manner, each flow passage defined by each primary delivery tube 132 carries product from one or more of the tanks to a secondary distribution tower 134 on the seeding tool 104. There may be one tower 134 for each primary delivery tube 132. Each tower 134 includes a secondary distributing manifold 136, which may be located at the top of a vertical tube. The secondary distribution manifold 136 divides the flow of product into several secondary distribution tubes 138. Each secondary distribution tube 138 delivers product to one of a plurality of ground engaging tools 140 (also known as ground openers or furrow openers) that define the locations of work points on seeding tool 104. The ground engaging tools (or furrow openers) 140 open a furrow in the soil 144 and facilitate deposit of the product therein. The number of primary delivery tubes 132 that feed into secondary distribution may vary from one to eight or ten or more, depending at least upon the configuration of the commodity cart 108 and seeding tool 104. Depending upon the cart and implement, there may be two distribution manifolds 136 in the air stream between the dispensers 124 and the ground engaging tools 140. Alternatively, in some configurations, the product is metered or dispensed directly from the tank or tanks into secondary distribution lines that lead to the ground engaging tools 140 without any need for an intermediate distribution manifold. The product dispensing system 124 can be configured to vary the rate of delivery of seed or other material to each work point on seeding tool 104 or to different sets or zones or sections of work points on seeding tool 104. The configurations described herein are only examples. Other configurations are possible and should be considered contemplated and within the scope of the present description.

A firming or closing wheel 142 associated with each seeding tool 140 trails the tool and firms the soil over the product deposited in the soil. In practice, a variety of different types of tools 140 are used including, but not necessarily limited to, tines, shanks and disks. Tools 140 are typically moveable between a lowered position engaging the ground and a raised position riding above the ground. Each individual tool 140 may be configured to be raised by a separate actuator. Alternatively, multiple tools 140 (or sections of tools) may be mounted to a common component for movement together. In yet another alternative, tools 140 may be fixed to the frame 128, the frame being configured to be raised and lowered with the tools 140.

FIG. 1A shows that agricultural system 100 can also include a speed control system 146. In one example, speed control system 146 is deployed on tractor 106 and automatically controls load accommodation functionality (such as the engine speed and/or gear ratio of the transmission) in the propulsion system of tractor 106, to control the ground speed of tractor 106, based upon a speed set point. The speed set point can be input by an operator. The operator may be a manual operator, an automated operator, or a semi-automated operator.

Speed control system 146 also illustratively has a terrain-based load anticipation control system (one example of which is described in more detail below) that identifies the route of tractor 106 and looks forward, along that route, to identify changes in pitch over which tractor 106 will be traveling as it follows the route. Based upon the magnitude of the changes in pitch, and based upon the location of the changes in pitch, the terrain-based load anticipation control system generates an adjustment value which may indicate an adjustment to the engine speed and/or the gear ratio that can be applied to the load accommodation functionality in the propulsion system of tractor 106 in order to maintain the desired ground speed of tractor 106 even as tractor 106 transitions through the changes in pitch.

FIG. 1B shows an example of two different mobile agricultural machines performing two different operations. One mobile agricultural machine is harvester 101 performing a harvesting operation, and the other is tractor 106 (which may be similar to tractor 106 shown in FIG. 1A or different) pulling a grain cart 156. FIG. 1B shows that agricultural harvester 101 includes an operator compartment 121, a clean grain tank 150, and a header 152. As header 152 engages crop, the crop is moved through a feeder house into the internal processing functionality in harvester 101. Clean grain enters clean grain tank 150 and is unloaded from clean grain tank 150 through a spout 154 into grain cart 156.

It can be seen from FIG. 1B that it may be important for mobile agricultural machines 101 and 106 to maintain a desired speed in order to maintain a desired spatial relationship between harvester 101 and grain cart 156 so that the grain exiting spout 154 is properly unloaded into grain cart 156. If either or both mobile agricultural machines 101 and 106 undergo undesirable speed changes, this may result in a misalignment between the output end of spout 154 and grain cart 156, resulting in clean grain being unloaded from clean grain tank 150 onto the ground.

Therefore, in one example, one or both mobile agricultural machines 101, 106 may have a speed control system 146. As with speed control system 146 shown in FIG. 1A, speed control system 146 in FIG. 1B can look ahead along the route of the mobile agricultural machines 101, 106 to identify upcoming changes in pitch. Based upon the changes in pitch, the speed control system 146 can adjust the load accommodation functionality (the engine speed and/or gear ratio) of the corresponding mobile agricultural machine 101, 106 to maintain the desired speed.

FIG. 1C is a top view showing another example of an agricultural system in which a mobile agricultural machine (tractor 106) is pulling a tillage implement 160. Tractor 106 is pulling tillage implement 160 along a route indicated by arrow 162. When tillage implement 160 is engaging the soil, it can impart relatively high draft forces on to tractor 106. If tractor 106 encounters a sudden change in pitch, this can result in tractor 106 stalling or at least significantly slowing down. Therefore, as with the example shown in FIGS. 1A and 1B, tractor 106 can have a speed control system 146 which looks ahead along route 162 to identify upcoming changes in pitch. Based upon the location of those changes in pitch, and the magnitude of the changes in pitch, speed control system 146 can generate adjustments to the load accommodation functionality (engine speed and/or gear ratio) to maintain a desired ground speed, even as mobile agricultural machine 106 traverses the changes in pitch.

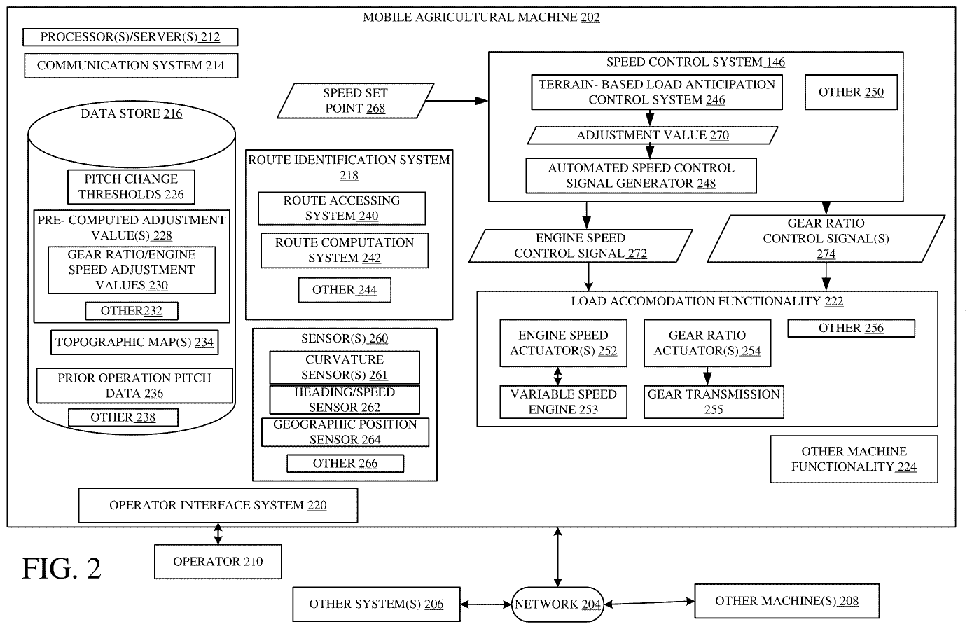

FIG. 2 is a block diagram showing one example of an agricultural system 200 in which a mobile agricultural machine 202 can perform an agricultural operation. Mobile agricultural machine 202 can be any of the mobile agricultural machines described above with respect to FIG. 1A-1C, or other mobile agricultural machines. In the example shown in FIG. 2, mobile agricultural machine 202 can communicate over network 204 with other systems 206 and/or other machines 208. Other systems 206 can be manager systems, vendor systems, manufacturer systems, maintenance systems, etc. Systems 206 can be located at remote server environments (e.g., in the cloud) or elsewhere. Other machines 208 can include other machines operating in the same field as mobile work machine 202 or tender vehicles or other machines. Network 204 can be a wide area network, a local area network, a near field communication network, a Wi-Fi or Bluetooth network, a cellular communication network, and/or any of a wide variety of other networks or combinations of networks.

FIG. 2 also shows that mobile work machine 202 can be controlled by an operator 210. Operator 210 can be a human operator, an automated operator, a semi-automated operator, etc.

In the example shown in FIG. 2, mobile work machine 202 can include one or more processors or servers 212, communication system 214, data store 216, route identification system 218, operator interface system 220, speed control system 146, load accommodation functionality 222, sensors 260, and any of a wide variety of other machine functionality 224. Data store 216 can include pitch change thresholds 226, pre-computed adjustment values 228 (which may include gear ratio/engine speed adjustment values 230, or other adjustment values 232), topographic maps 234, prior operation pitch data 236, and/or any of a wide variety of other items 238. Route identification system 218 can include route accessing system 240, route computation system 242, or other items 244. Speed control system 146 can include terrain-based load anticipation control system 246, automated speed control signal generator 248, and other items 250. Load accommodation functionality 222 can include one or more engine speed actuators 252, one or more gear ratio actuators 254, and/or any of a wide variety of other items 256. Sensors 260 can include curvature sensor(s) 261, headings/speed sensors 262, geographic position sensor 264, and/or other sensors 266. Before describing the operation of agricultural system 200 in more detail, a description of some of the items in agricultural system 200, and their operation, will first be provided.

Communication system 214 illustratively facilitates communication among the items in mobile work machine 202 with one another and communication over network 204. Therefore, communication system 214 can be a controller area network (CAN) bus and bus controller, a cellular communication system, a wide area network communication system, a local area network communication system, Ethernet, a Bluetooth and/or Wi-Fi communication system, a near field communication system, or other systems or combinations of systems.

Pitch change thresholds 226 may be threshold pitch values (e.g., in degrees or other units) which can be used to identify when an adjustment is to be made to engine speed and/or gear ratio and, if so, the magnitude of the engine speed and/or gear ratio adjustment. There may be one or more pitch change thresholds 226 that can be used to identify adjustments. The pitch change thresholds may be different depending on the type of mobile agricultural machine 202, depending on the engine power or rated engine power, depending on the particular operation that mobile agricultural machine 202 is performing (e.g., tilling, towing a grain cart, harvesting, etc.) or depending on other conditions.

Also, there may be a plurality of pitch change thresholds 226 for a single mobile agricultural machine 202. For instance, a first pitch change threshold may be set at 10° so that when the pitch over which mobile agricultural machine 202 is predicted to travel is estimated to increase by 10°, then a particular adjustment is to be made. However, another pitch threshold may be set at 15° so that when the pitch of the terrain over which mobile agricultural machine 202 is predicted to travel is predicted to increase by 15°, then a different adjustment is to be made. Further, a different pitch threshold may be under different circumstances. For example, there may be a first pitch threshold value that is to be used when mobile agricultural machine 202 is currently traveling on level terrain. There may be a different pitch threshold used when mobile agricultural machine 202 is currently traveling at a negative pitch (e.g., downhill). As an example, if mobile agricultural machine 202 is currently traveling on level ground and the upcoming pitch increases by 10°, then an adjustment to the engine speed and/or gear ratio may be needed. However, if mobile agricultural machine 202 is currently traveling downhill (at a pitch of −10°) and the upcoming pitch increases by 10°, this means that, even after the upcoming change in pitch, mobile agricultural machine 202 will be traveling on level ground. Thus, this may mean that no adjustment is needed. These are examples only and a variety of other pitch thresholds can be used as well.

Pre-computed adjustment values 228 may be adjustment values that can be implemented based upon the pitch or load changes that will be experienced by mobile agricultural machine 202. For instance, each pitch change threshold 222 may have a corresponding pre-computed adjustment value 228 so that when the upcoming pitch change meets a pitch change threshold, then the corresponding adjustment can be retrieved from data store 216 and applied to the load accommodation functionality 222. Thus, the pre-computed adjustment values 228 may be gear ratio or engine speed adjustment values 230, or other adjustment values 232.

Topographic maps 234 may be maps that have geo-referenced topography information. The geo-referenced topography information may be used to identify changes in pitch as mobile agricultural machine 202 travels along a route through the mapped area.

Prior operation pitch data 236 may be data that reflects changes in pitch that were detected during a prior operation. For instance, during a planting operation, a tractor pulling a planter may detect and store pitch change values so those values can be geo-referenced in the field over which the tractor is traveling. Those pitch change values can be stored as prior operation pitch dated 236 so that, as mobile agricultural machine 202 travels through the same field (e.g., while performing a subsequent operation), the pitch change values can be extracted from data store 216 and used to generate adjustment values for upcoming changes in pitch.

Curvature sensors 261 sense the curvature of mobile agricultural machine 202. The curvature can be used to identify the future location of machine 202. For example, on wheeled vehicles, curvature sensors 261 can be wheel angle sensors that are used to sense the steering angle of the wheels. Curvature sensors 261 can also be used to sense the movement or engagement of tracks to identify machine curvature on track vehicles. Heading/speed sensors 262 detect a heading characteristic (e.g., machine orientation, travel direction, etc.) and/or speed characteristic (e.g., travel speed, acceleration, deceleration, etc.), of a mobile agricultural machine 202. Sensors 262 can thus include sensors that sense the movement (e.g., speed of rotation) of ground-engaging elements (e.g., wheels or tracks), or movement of components coupled to the ground engaging elements (e.g., axles) or other elements, or can utilize signals received from other sources, such as geographic position sensors 264 (described below). Thus, sensors 262 can be Hall effect sensors, angle encoders, rotary position sensors, linear sensors, or other sensors. Further, while heading/speed sensors 262 as described herein are shown as separate from geographic position sensors 264, in some examples, machine heading/speed is derived from signals received from geographic position sensors 264 and subsequent processing. In other examples, heading/speed sensors 262 are separate sensors and do not utilize signals received from other sources. Thus, heading/speed sensors 262 can also include a speedometer, inertial measurement units, gyroscopic sensors, accelerometers, and/or other sensors that can provide an orientation or heading and speed of mobile agricultural machine 202.

Geographic position sensor 264 illustratively senses or detects the geographic position or location of mobile agricultural machine 202. Geographic position sensors 264 can include, but are not limited to, a global navigation satellite system (GNSS) receiver that receives signals from a GNSS satellite transmitter. Geographic position sensors 264 can also include a real-time kinematic (RTK) component that is configured to enhance the precision of position data derived from the GNSS signal. Geographic position sensors 264 can include a dead reckoning system, a cellular triangulation system, or any of a variety of other geographic position sensors.

Route identification system 218 identifies the route being traveled by mobile agricultural machine 202. Where mobile agricultural machine 202 is being automatically navigated along a route by a navigation system, then route accessing system 240 can access the route being used by the navigation system. Where the route of mobile agricultural machine 202 is generated by a path planning system, then route accessing system 240 may access that route from the path planning system. Route accessing system 240 may access the route of mobile agricultural machine 202 from other systems that automatically generate a route or that generate a route in other ways.

Route computation system 242 is configured to compute the route of mobile agricultural machine 202 where the route is not accessible by route accessing system 240. For instance, route computation system 242 may receive an input from one or more sensors 261, 262 and 264 indicating the heading and direction of travel of mobile agricultural machine 202, as well as the geographic location (e.g., latitude, longitude), and estimated curvature of mobile agricultural machine 202. By tracking and extrapolating between a plurality of geographic locations, route computation system 242 can compute the route that has already been traveled by mobile agricultural machine 202. Given the heading and direction of travel of mobile agricultural machine 202, and given the prior route traveled by mobile agricultural machine 202, route computation system 242 can estimate a future route of mobile agricultural machine 202 as well. Further, route computation system 242 may receive inputs from other sensors, such as wheel angle sensors that sense the angle of steerable wheels on mobile agricultural machine 202. Route computation system 242 can estimate the future route of mobile agricultural machine 202 based upon these inputs as well.

Operator interface system 220 can include operator interface mechanisms that can be used by operator 210 in the operator compartment of mobile agricultural machine 202 to control and manipulate mobile agricultural machine 202. Therefore, those operator interface mechanisms can include joysticks, a steering wheel, peddles, levers, linkages, buttons, etc. Further, the operator interface mechanisms can include a display screen that displays information to the operator 210 and that receives inputs from operator 210 through operator actuatable input mechanisms such as links, icons, buttons, etc. The display screen may be a touch sensitive screen where the operator interface mechanisms can be actuated using touch gestures. Further, operator interface system 220 can include a microphone and speaker where speech recognition and speech synthesis are provided and can include a wide variety of other mechanisms that provide audio, visual, and/or haptic outputs to an operator 210 and/or receive inputs from an operator 210.

Speed control system 146 automatically controls the speed of mobile agricultural machine 202 based upon a speed set point 268. Speed set point 268 can be a default speed set point, a speed set point provided by operator 210, or a speed set point obtained in other ways.

Automated speed control signal generator 248 receives the speed set point 268 and automatically generates engine speed control signal 272 and gear ratio control signal 274. Engine speed control signal 272 can be applied to engine speed actuators 252 (which may include such things as a throttle or other actuators) that are actuated to change the engine speed. Gear ratio control signals 274 can be applied to gear ratio actuators 254 (which can include such things as a clutch and shifting functionality) to change the gear ratio of the transmission in mobile agricultural machine 202. Automated speed control signal generator 248 thus controls the engine speed and gear ratio to maintain the speed indicated by speed set point 268.

Terrain-based load anticipation control system 246 looks ahead along the route output by route identification system 218 to identify changes in pitch that mobile agricultural machine 202 will undergo as it travels along that route. Based upon the changes in pitch, terrain-based load anticipation control system 246 generates an adjustment value 270 that can be used by automated speed control signal generator 248 to identify and select a gear ratio and/or engine speed best suited to handle the upcoming pitch-induced load change. In one example, automated speed control signal generator 248 can select a gear ratio and/or engine speed to achieve or maintain the speed of mobile agricultural machine 202 at the speed identified by the speed set point 268. Automated speed control signal generator 248 can thus generate an engine speed control signal 272 and/or a gear ratio control signal 274 to control the engine speed and/or gear ratio of the transmission to best maintain the desired speed indicated by speed set point 268 over the upcoming changes in pitch as mobile agricultural machine 202 travels along the route of mobile agricultural machine 202. In another example, automated speed control signal generator 248 selects a gear ratio and/or engine speed in an attempt to maintain the speed of mobile agricultural machine 202 at the speed identified by the speed set point 268, while also providing enough engine power to satisfy upcoming power needs. Further, automated speed control signal generator 248 selects a gear ratio and/or engine speed that does not significantly overshoot the power needs (e.g. exceed the upcoming power needs by a threshold amount, such as 15%, 20%, 25%, etc. for example) so as to maintain efficient operation. Instead, if the pitch-induced load increase is large, then automated speed control signal generator 248 selects a gear ratio and sets engine speed to maximum to generate more inertia to better handle the increased load. If the upcoming pitch-induced load increase is moderate, then automated speed control signal generator 248 selects a gear ratio and/or engine speed that provides a more moderate response.

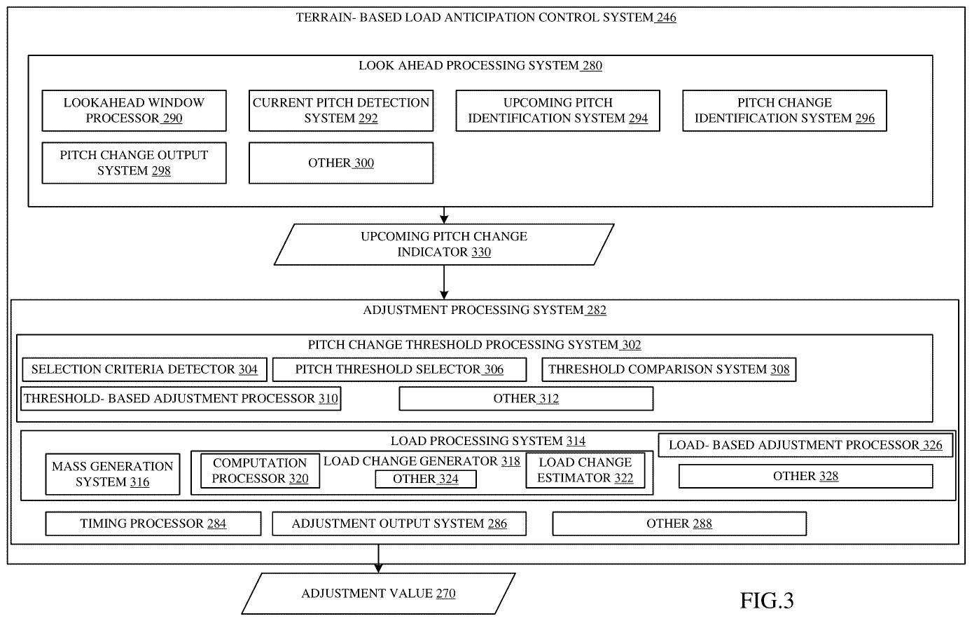

FIG. 3 is a block diagram showing one example of the terrain-based load anticipation control system 246 in more detail. In the example shown in FIG. 3, system 246 includes lookahead processing system 280, adjustment processing system 282, timing processor 284, adjustment output system 286, and other items 288. Lookahead processing system 280 includes lookahead window processor 290, current pitch detection system 292, upcoming pitch identification system 294, pitch change identification system 296, pitch change output system 298, and other items 300. Adjustment processing system 282 includes pitch change threshold processing system 302. System 302 can include selection criteria detector 304, pitch threshold selector 306, threshold comparison system 308, threshold-based adjustment processor 310, and other items 312. Adjustment processing system 282 can also include load processing system 314. Load processing system 314 can include mass generation system 316, load change generator 318 (which can include computation processor 320, load change estimator 322, and other items 324), load-based adjustment processor 326, and other items 328. Before describing the operation of terrain-based load anticipation control system 246 in more detail, a description of some of the items in system 246, and their operation, will first be provided.

Lookahead window processor 290 receives the route of mobile agricultural machine 202 output by route identification system 218 and identifies a distance along that route (the lookahead window) that needs to be examined for changes in pitch. The distance may be based upon the ground speed of mobile agricultural machine 202, as output by heading/speed sensor 262. The lookahead window may also be based on how quickly engine speed actuators 252 can change the engine speed and how quickly gear ratio actuators 254 can change the gear ratio. The lookahead window can be a default distance or a dynamically changing distance that changes in other ways.

Current pitch detection system 292 identifies a current pitch of mobile agricultural machine 202. The current pitch can be computed based upon an output from heading/speed sensor 262 (where sensor 262 includes an orientation sensor, such as an accelerometer, gyroscopic sensor, that functions as a pitch sensor, etc.). In one example, the current pitch value is generated by aggregating sensed pitch values over a time period or travel distance (such as by averaging sensed pitch values over the previous 10 seconds or 10 meters of distance traveled) to account for noise in the sensed pitch values. In another example, current pitch detection system 292 can receive the current heading of mobile agricultural machine 202 from heading/speed sensor 264, the current geographic position of mobile agricultural machine 202 from geographic position sensor 264, and the pitch at the current location from a topographical map 234. Current pitch detection system 292 can identify the current pitch of mobile agricultural machine 202 based on that information.

Upcoming pitch identification system 294 can access topographic maps 234 or prior operation pitch data 236 to identify upcoming changes in changes in the topography of the field along the route of mobile agricultural machine 202. Based upon the current pitch of mobile agricultural machine 202 and the upcoming changes in topography output by upcoming pitch identification system 294, pitch change identification system 296 can identify upcoming changes in pitch, along with the location of those changes in pitch. For instance, pitch change identification system 296 can subtract the current pitch from the upcoming pitch along the route of mobile agricultural machine 202 to identify an upcoming change in pitch.

Pitch change output system 298 outputs an upcoming pitch change indicator 330. The upcoming pitch change indicator 330 can identify the magnitude of the upcoming pitch change, the direction of the pitch change (e.g., whether the pitch change is a positive pitch change or negative pitch change), the geographic location where the pitch change will occur, and/or a time in the future where the pitch change will occur (e.g., based upon the distance that the pitch change will occur from the current location as well as the current ground speed of mobile agricultural machine 202).

Adjustment processing system 282 receives the upcoming pitch change indicator 330 and determines whether an adjustment to the engine speed and/or gear ratio should be made, the magnitude of that adjustment, and the timing indicative of when the adjustment should be made. Pitch change threshold processing system 302 can identify whether an adjustment should be made by comparing the upcoming pitch change to a pitch change threshold 226. For instance, when the pre-computed adjustment values 228 are computed for mobile work machine 202 and correlated to the pitch change thresholds 226, then pitch change threshold processing system 302 can compare the upcoming pitch change to the pitch change threshold. If the upcoming pitch change meets a pitch change threshold, then pitch change threshold processing system 302 can access the pre-computed adjustment value 228 corresponding to that pitch change threshold and thereby identify the value of adjustments that need to be made based on the upcoming pitch change.

Load processing system 314 can identify adjustments that need to be made based upon anticipated changes in the load on the engine driving mobile work machine 202. For instance, based upon the upcoming change in pitch and based upon the mass of mobile work machine 202, load processing system 314 can compute the anticipated upcoming load change and identify adjustments in engine speed and/or gear ratio that need to be made to accommodate the upcoming load change.

Timing processor 284 calculates when the adjustment should be made. For instance, timing processor 284 can determine how long it will be before mobile work machine 202 reaches the upcoming pitch change based upon the current speed of mobile work machine 202 and based upon the distance to the pitch change. Timing processor 284 can also detect or obtain the responsiveness of the engine speed actuators 252 and gear ratio actuators 254 (e.g., how quickly those actuators react to inputs) and determine when the adjustment value 270 should be applied to the actuators 252, 254 to implement the adjustments. Adjustment output system 286 can then generate the adjustment value 270, according to the desired timing, so that automated speed control signal generator 248 can generate the engine speed control signal 272 and/or the gear ratio control signal 274 at the desired time.

Returning again to pitch change threshold processing system 302, selection criteria detector 304 can detect threshold selection criteria to determine which of the pitch change thresholds 226 are to be selected and used in generating adjustment value 270. As discussed above, there may be a plurality of different pitch change thresholds 226 that are to be used under different circumstances. Selection criteria detector 304 detects selection criteria indicative of those circumstances to determine which pitch change threshold 226 to select. For instance, if there are different pitch change thresholds 226 corresponding to different magnitudes of pitch change, then selection criteria detector 304 can identify the magnitude of the upcoming pitch change from upcoming pitch change indicator 330 and select the appropriate corresponding pitch change threshold 226. If the threshold selection criteria include the current pitch of mobile agricultural machine 202 (so that the pitch change threshold 226 will depend on the current pitch of mobile agricultural machine 202), then selection criteria detector 304 can identify the current pitch of mobile agricultural machine 202 based upon the output of current pitch detection system 292 and select the corresponding pitch change threshold 226 accordingly. Where the criteria for selecting a pitch change threshold 226 include the type of agricultural operation being performed, the type of agricultural machine, or other criteria, then selection criteria detector 304 can detect those criteria through operator inputs, or through other detectable characteristics. Based upon the detected selection criteria, pitch threshold selector 306 selects one of the pitch change thresholds 226 to be used for generating adjustment values 270.

Threshold comparison system 308 compares the upcoming pitch change to the selected pitch change threshold 226 to generate a comparison result. Based upon the comparison result, threshold-based adjustment processor 310 generates the adjustment value 270. Threshold-based adjustment processor 310 can be a machine learning model, a rules-based algorithm, an artificial intelligence classifier, or another processor that receives, as an input, the comparison result output by threshold comparison system 308 (and any other desired inputs) and computes or outputs adjustment value 270 indicative of the adjustments that need to be made to the engine speed and/or gear ratio.

In another example, where the adjustment values are precomputed, then threshold-based adjustment processor 310 accesses the pre-computed adjustment values 228, based upon the comparison result to identify the gear ratio and/or engine speed adjustment value 230 that will be used to generate adjustment value 270. Pitch change threshold processing system 302 can identify adjustment values based upon a comparison of the upcoming pitch change to pitch change thresholds 226 in other ways as well.

Referring now to load processing system 314 which generates adjustment values 270 based upon the anticipated load change, mass generation system 316 first computes or estimates the mass of mobile agricultural machine 202. For instance, where mobile agricultural machine 202 is a tractor pulling a grain cart, then mass generation system 316 combines the mass of the tractor with an estimated mass of the grain cart (e.g., based upon the estimated or actual fill level of the grain cart, based on the density of the crop material in the grain cart, where the cart has scales, then based on the scale outputs, etc.) to obtain a mass value. Load change generator 318 then computes or estimates the upcoming load change based upon the upcoming pitch change and the mass of mobile agricultural machine 202.

However, where the mass of mobile agricultural machine 202 is not known, then load change estimator 322 can estimate that mass using a machine learning model, such as a regression model, and a set of data that has been collected during the current agricultural operation and/or during previous operations. For instance, load change estimator 322 can obtain power requirement/load data (such as speed and pitch) from sensors 260 as well as other data indicative of the power consumption on mobile agricultural machine 202. Such data can include the power being consumed by the power take off, the level of hydraulic fluid flow through various hydraulic valves, and/or other power requirement/load data. Based upon that data, load change estimator 322 can model the power consumption of mobile agricultural machine 202 and thus estimate the load change that will be encountered based upon the upcoming pitch change.

Load change generator 318 thus outputs either the computed load change or the estimated load change to load-based adjustment processor 326. Load-based adjustment processor 326 then computes the adjustment value 270 based upon the load change. Where the adjustment values are pre-computed and correlated to load change, then load-based adjustment processor 326 accesses the pre-computed adjustment values 228 to obtain gear ratio/engine speed adjustment values 230 correlated to the computed or estimated load change. Where adjustment values are not pre-computed, load-based adjustment processor 326 can calculate or estimate the adjustment values 270 based upon the computer estimated load change. In that scenario, load-based adjustment processor 326 may be a machine learning model, a rules-based algorithm, an artificial intelligence classifier, or another type of processor.

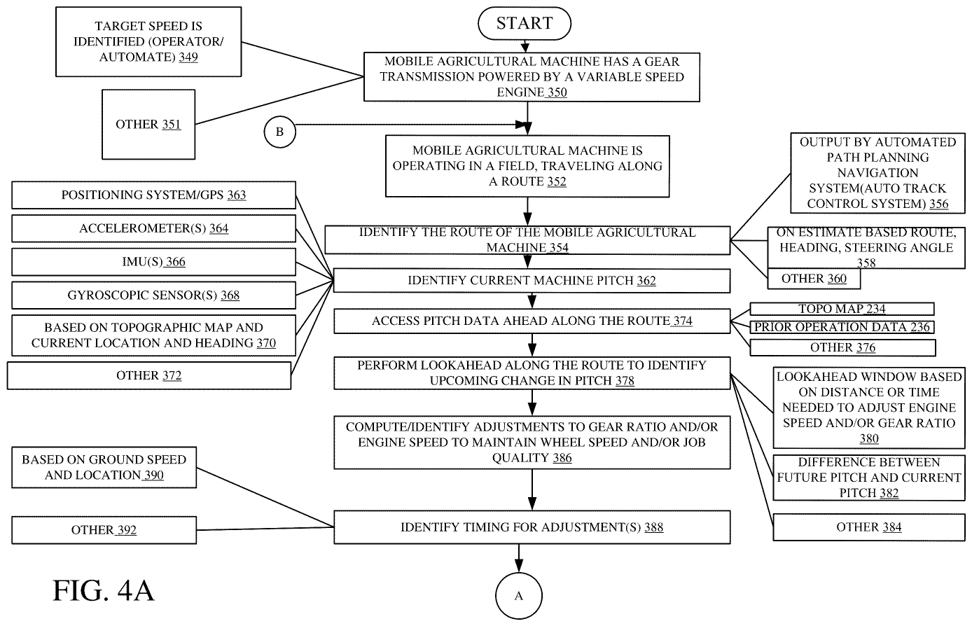

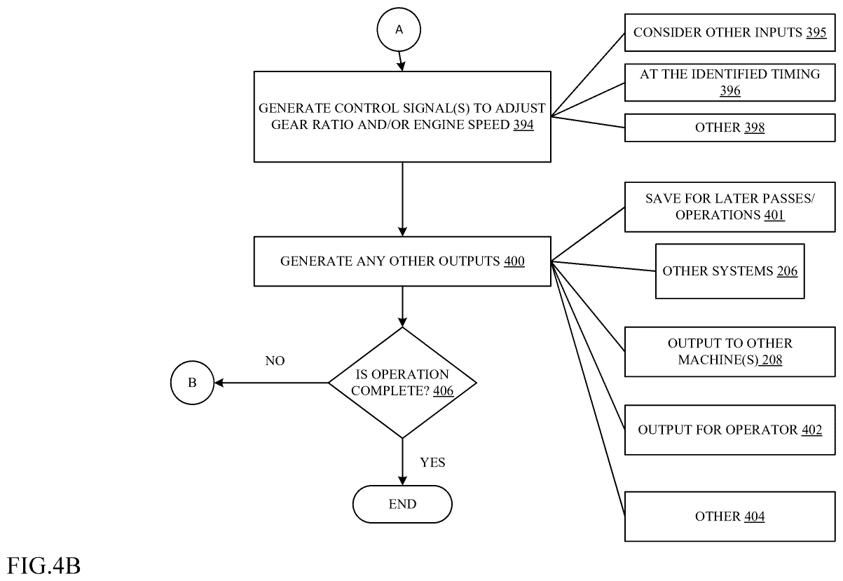

FIGS. 4A and 4B (collectively referred to herein as FIG. 4) show a flow diagram illustrating one example of the operation of mobile agricultural machine 202 in identifying upcoming changes in pitch and automatically generating adjustment values 270. By automatically it is meant, in one example, that the step, process, or method is performed without further human involvement except, perhaps, to initiate or authorize the step, process, or method.

In some implementations, the mobile agricultural machine 202 has a gear transmission that is powered by a variable speed engine, as indicated by block 350 in the flow diagram of FIG. 4 In some implementations, the mobile agricultural machine 202 is operating in a field and is traveling along a route, as indicated by block 352.

Route identification system 218 identifies the route of the mobile agricultural machine 202, as indicated by block 354. Route accessing system 240 can access the route when the route is output by an automated path planning or navigation system, as indicated by block 356. Route computation system 242 can estimate the route of mobile agricultural machine 202 based upon the past route, the heading, the steering angle, and/or any of a wide variety of other characteristics, as indicated by block 358. The route of the mobile agricultural machine 202 can be obtained in other ways as well, as indicated by block 360.

Current pitch detection system 292 then identifies a current machine pitch of mobile agricultural machine 202, as indicated by block 362. The current machine pitch can be detected from a positioning system, such as a GPS receiver 363, accelerometers 364, IMUs 366, gyroscopic sensors 368, or based upon information in topographic map 234 and the current location and heading of mobile work machine 202, as indicated by block 370. The current machine pitch can be detected in other ways as well, as indicated by block 372.

Upcoming pitch identification system 294 then accesses pitch data along the route of mobile agricultural machine 202 ahead of mobile agricultural machine 202 in the direction of travel, as indicated by block 374. The pitch data ahead of mobile agricultural machine 202 can be obtained from topographic map 234, from prior operation pitch data 236, or in other ways 376.

Pitch change identification system 296 then performs an automatic lookahead along the route of mobile agricultural machine 202 to identify upcoming changes in pitch, as indicated by block 378. The distance of the lookahead operation (the lookahead window) may be based upon the speed of mobile agricultural machine 202 and/or the distance or time needed to adjust the engine speed and/or gear ratio, as indicated by block 380. The upcoming changes in pitch can be computed by subtracting the current pitch of mobile agricultural machine 202 from the upcoming pitch as indicated by block 382. In one example, the current pitch value may be an aggregated value, such as an average of the current pitch over a previous time or distance interval (e.g., the average pitch over the previous X seconds or Y meters of travel). Performing the automated lookahead along the route of mobile agricultural machine 202 to identify upcoming changes in pitch can be done in other ways as well, as indicated by block 384.

Adjustment processing system 282 then automatically computes or identifies adjustment values 270 to be made to the gear ratio and or the engine speed to maintain the desired wheel speed of mobile agricultural machine 202 and/or to maintain job quality, as indicated by block 386. For example, where the job quality is affected by the ground speed, maintaining the ground speed at a desired speed will also maintain the job quality at a desired job quality level.

Once the adjustment values 270 are identified, timing processor 284 identifies the timing for the adjustments, as indicated by block 388. The timing can be based upon the ground speed and location of mobile agricultural machine 202, as indicated by block 390, as well as other criteria, such as the responsiveness of the engine speed actuators 252 and the gear ratio actuators 254 or based on other criteria or characteristics as indicated by block 392 in the flow diagram of FIG. 4.

Automated speed control signal generator 248 then automatically generates engine speed control signals 272 and/or gear ratio control signals 274 to control the engine speed and/or the gear ratio, as indicated by block 394 in the flow diagram of FIG. 4. In one example, the engine speed control signals 272 and/or gear ratio control signals 274 are a subset of suggested control signals for controlling engine speed and/or gear ratio. Other inputs, from other systems, can be considered as well. The speed control system 146 can decide (based on a predetermined or dynamic priority, or in other ways, how to generate the control signals. Considering a plurality of inputs in generating the speed and gear ratio control signals is indicated by block 395. Signals 272 and/or 274 can be output according to the identified timing information, as indicated by block 396 or in other ways, as indicated by block 398. Speed control system 146 can generate any other outputs, as indicated by block 400 as well. Such outputs can be to save the upcoming pitch changes 330, the adjustment values 270, and/or other data, so that such information can be used on later passes or operations, as indicated by block 401. Such information can also be output to other machines 208, other systems 206, for operator interaction as indicated by block 402, or in other ways as indicated by block 404.

Until the agricultural operation is complete, as determined at block 406, processing reverts to block 352 where mobile agricultural machine 202 continues operating in the field and traveling along its route.

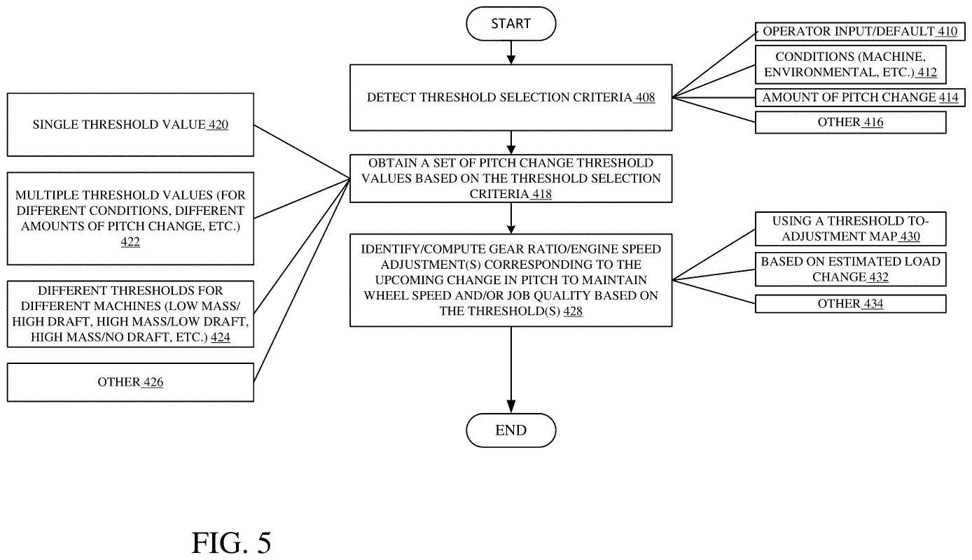

FIG. 5 is a flow diagram showing one example of the operation of pitch change threshold processing system 302 in more detail In some implementations, the lookahead processing system 280 has provided upcoming pitch change indicators 330 which are indicative of the upcoming pitch changes. Selection criteria detector 304 then detects threshold selection criteria as indicated by block 408 in the flow diagram of FIG. 5. The threshold selection criteria can include operator inputs or default threshold selections, as indicated by block 410. The threshold selection criteria can include such things as the machine conditions, environmental conditions, the operation being performed, the particular form of mobile agricultural machine 202, or other conditions, as indicated by block 412. The threshold selection criteria can be based upon the amount or magnitude of the upcoming pitch change, as indicated by block 414, or based on any of a wide variety of other selection criteria as indicated by block 416.

Based upon the threshold selection criteria, pitch threshold selector 306 obtains a set of pitch change threshold values 226, as indicated by block 418. The set of pitch change threshold values 226 can include a single threshold value 420, or multiple different threshold values that can be used under different conditions, based on different amounts of pitch change, etc., as indicated by block 422. The set of pitch change threshold values can include different threshold values for different machines, such as indicated by block 424. For instance, one set of threshold values may be obtained for a machine that has a relatively low mass but high draft forces (such as a tractor pulling a tillage implement that is engaging the ground). A different set of threshold values can be obtained for a machine that has high mass but low draft forces, such as a tractor pulling a filled grain cart. Still a different set of threshold values may be obtained for a machine that has high mass but no draft forces (such as an agricultural harvester with a full clean grain tank). The threshold values may be obtained in other ways as well, as indicated by block 426.

Threshold-based adjustment processor 310 then identifies or computes a gear ratio and/or engine speed adjustment corresponding to the upcoming change in pitch in order to maintain the wheel speed and/or job quality of mobile agricultural machine 202 based upon the selected threshold value. Identifying or computing the adjustments is indicated by block 428 in the flow diagram of FIG. 5. In one example, the adjustments are based upon an output from threshold comparison system 308 which compares the upcoming pitch change to the threshold values, as indicated by block 430. Threshold-based adjustment processor 310 may obtain the adjustment values from a threshold-to-adjustment mapping 432 which may, for instance, be indicated by pre-computed adjustment values 228. The adjustments can be identified or computed in a wide variety of other ways as well, as indicated by block 434.

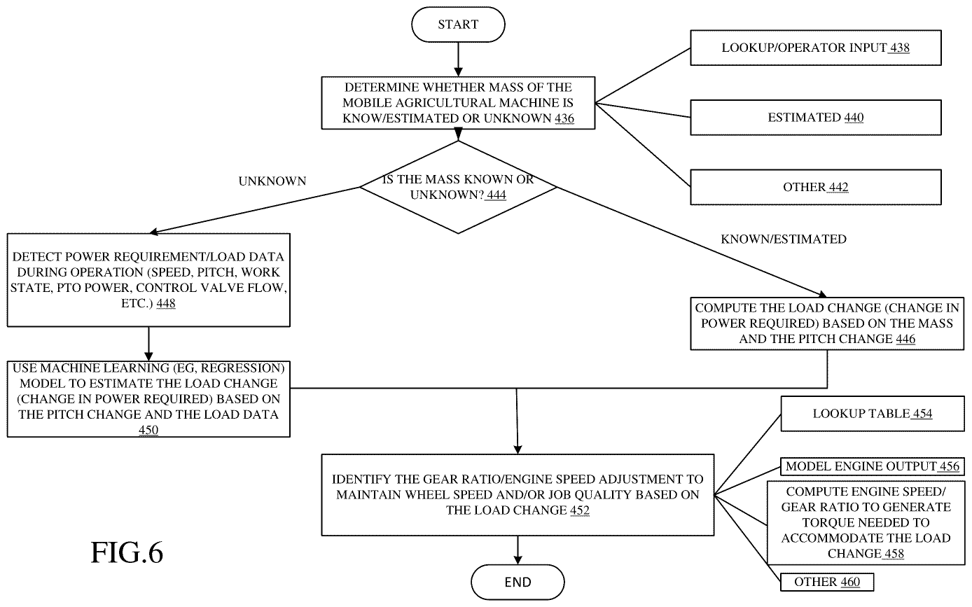

FIG. 6 is a flow diagram illustrating one example of the operation of load processing system 314 in more detail. Mass generation system 316 first determines whether the mass of mobile agricultural machine 202 is known (or can be estimated), or is unknown, as indicated by block 436 in the flow diagram of FIG. 6. For instance, the mass can be known if it is detected or provided in data store 216 and/or is provided through an operator input, as indicated by block 438. In another example, the mass may be estimated if, for instance, the mass of a tractor and grain cart are known, and the mass of the grain in the grain cart is estimated, as indicated by block 440. Determining whether the mass of the mobile agricultural machine 202 is known (or can be estimated) or is unknown, can be done in other ways as well, as indicated by block 442.

If, as determined at block 444, the mass of mobile agricultural machine 202 is known or can be estimated, then computation processor 320 computes the load change (the change in power required) based upon the mass of mobile agricultural machine 202 and the upcoming pitch change indicated by upcoming pitch change indicator 330. Computing the load change in this way as indicated by block 446 and the flow diagram of FIG. 6.

If, however, at block 444, it is determined that the mass of mobile agricultural machine 202 is not known, then load change estimator 322 detects power requirement/load data during the operation of mobile agricultural machine 202, as indicated by block 448. The power requirement/load data can include such things as ground speed, machine orientation or pitch, the work state of the machine (such as whether the header of an agricultural harvester is engaged, whether a tillage implement is engaging the ground during a tillage operation, whether fans are turned on, the power being consumed by a power take off, hydraulic flow through one or more different control valves, etc.). Load change estimator 322 then uses a machine learning (e.g., regression) model to estimate the load change (the change in power required) based upon the upcoming pitch change. For instance, load change estimator 322 can use the power requirement/load data to estimate changes in power requirements that are due to changes in pitch during the operation of mobile work machine 202 and thus to identify power requirements that are not due to changes in pitch as well. The power requirements that are not due to terrain pitch (such as fan power, PTO power, power used by an implement, etc) can then be factored out when identifying changes in power requirements due to terrain-based load changes. Once the load change estimator 322 identifies how engine load varies due to changes in pitch, this information can then be used to estimate the change in power that will be required to accommodate the upcoming change in pitch.

Whether the upcoming load change is computed or estimated, load-based adjustment processor 326 then identifies the gear ratio/engine speed adjustment that will be needed to maintain the wheel speed and/or job quality, based upon the load change. Identifying the gear ratio/engine speed adjustment values is indicated by block 452 and the flow diagram of FIG. 6. Again, load-based adjustment processor 326 can obtain the adjustment values 270 from a lookup table in data store 216 where the adjustment values are pre-computed adjustment values 228. Obtaining the adjustment values from a lookup table as indicated by block 454. The adjustment values can be obtained using a dynamic model or AI classifier or other system that models the engine output, as indicated by block 456. Load-based adjustment processor 326 can identify the adjustment values by computing the engine speed and/or gear ratio that is needed to generate sufficient torque to accommodate the load change, as indicated by block 458. The gear ratio and/or engine speed adjustment values can be identified in other ways as well, as indicated by block 460.

It can thus be seen that the present description describes a system which includes a terrain-based load anticipation control system that calculates adjustments to engine speed and/or gear ratio, automatically, based upon upcoming changes in pitch. The engine speed and/or gear ratio adjustments can be calculated to maintain a ground speed or wheel speed of mobile agricultural machine 202 at a desired ground speed or wheel speed, and/or to maintain a desired job quality of mobile agricultural machine 202. The present description thus reduces the likelihood of slowing wheel speed and/or engine stalls when mobile agricultural machine 202 encounters significant changes in pitch while performing an agricultural operation.

The present discussion has mentioned processors and servers. In one example, the processors and servers include computer processors with associated memory and timing circuitry, not separately shown. The processors or servers are functional parts of the systems or devices to which they belong and are activated by and facilitate the functionality of the other components or items in those systems.

Also, a number of user interface (UI) displays have been discussed. The UI displays can take a wide variety of different forms and can have a wide variety of different user actuatable input mechanisms disposed thereon. For instance, the user actuatable input mechanisms can be text boxes, check boxes, icons, links, drop-down menus, search boxes, etc. The mechanisms can also be actuated in a wide variety of different ways. For instance, the mechanisms can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which the mechanisms are displayed is a touch sensitive screen, the mechanisms can be actuated using touch gestures. Also, where the device that displays the mechanisms has speech recognition components, the mechanisms can be actuated using speech commands.

A number of data stores have also been discussed. It will be noted the data stores can each be broken into multiple data stores. All can be local to the systems accessing the data stores, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

It will be noted that the above discussion has described a variety of different systems, components, generators, detectors, selectors, estimators, and/or logic. It will be appreciated that such systems, components, generators, detectors, selectors, estimators, and/or logic can be comprised of hardware items (such as processors and associated memory, or other processing components, some of which are described below) that perform the functions associated with those systems, components, generators, detectors, selectors, estimators, and/or logic. In addition, the systems, components, generators, detectors, selectors, estimators, and/or logic can be comprised of software that is loaded into a memory and is subsequently executed by a processor or server, or other computing component, as described below. The systems, components, generators, detectors, selectors, estimators, and/or logic can also be comprised of different combinations of hardware, software, firmware, etc., some examples of which are described below. These are only some examples of different structures that can be used to form the systems, components, generators, detectors, selectors, estimators, and/or logic described above. Other structures can be used as well.

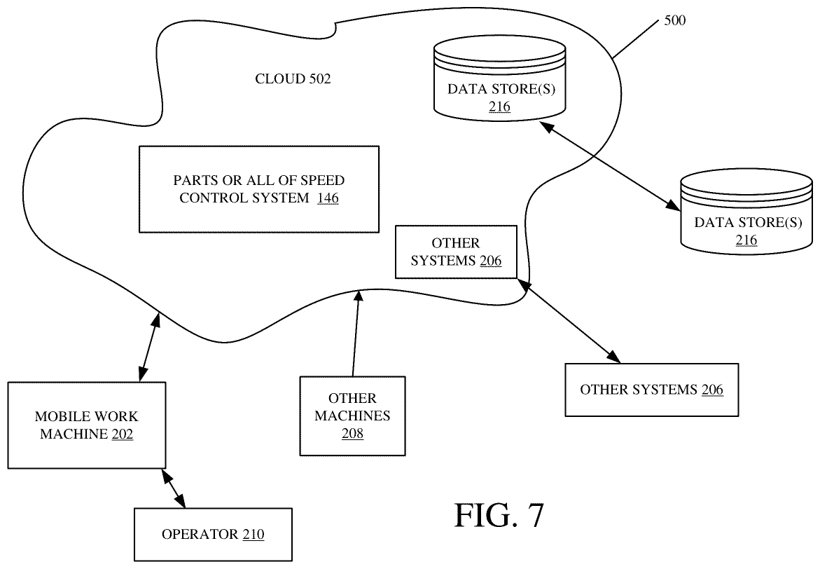

FIG. 7 is a block diagram of a mobile work machine 202, shown in previous FIGS., except that it communicates with elements in a remote server architecture 500. In an example, remote server architecture 500 can provide computation, software, data access, and storage services that do not require end-user knowledge of the physical location or configuration of the system that delivers the services. In various examples, remote servers can deliver the services over a wide area network, such as the internet, using appropriate protocols. For instance, remote servers can deliver applications over a wide area network, and they can be accessed through a web browser or any other computing component. Software or components shown in previous FIGS. as well as the corresponding data, can be stored on servers at a remote location. Computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, the components and functions can be provided from a conventional server, or they can be installed on client devices directly, or in other ways.

In the example shown in FIG. 7, some items are similar to those shown in previous FIGS. and they are similarly numbered. FIG. 7 specifically shows other systems 206, parts or all of speed control system 146, and/or data store 216 can be located at a remote server location 502. Therefore, mobile work machine 202 accesses those systems through remote server location 502.

FIG. 7 also depicts another example of a remote server architecture. FIG. 7 shows that it is also contemplated that some elements of previous FIGS are disposed at remote server location 502 while others are not. By way of example, data store 216 or other systems 206 can be disposed at a location separate from location 502, and accessed through the remote server at location 502. Regardless of where the items are located, they can be accessed directly by mobile agricultural vehicle 202, through a network (either a wide area network or a local area network), the items can be hosted at a remote site by a service, or the items can be provided as a service, or accessed by a connection service that resides in a remote location. Also, the data can be stored in substantially any location and intermittently accessed by, or forwarded to, interested parties. All of these architectures are contemplated herein.

It will also be noted that the elements of previous FIGS., or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

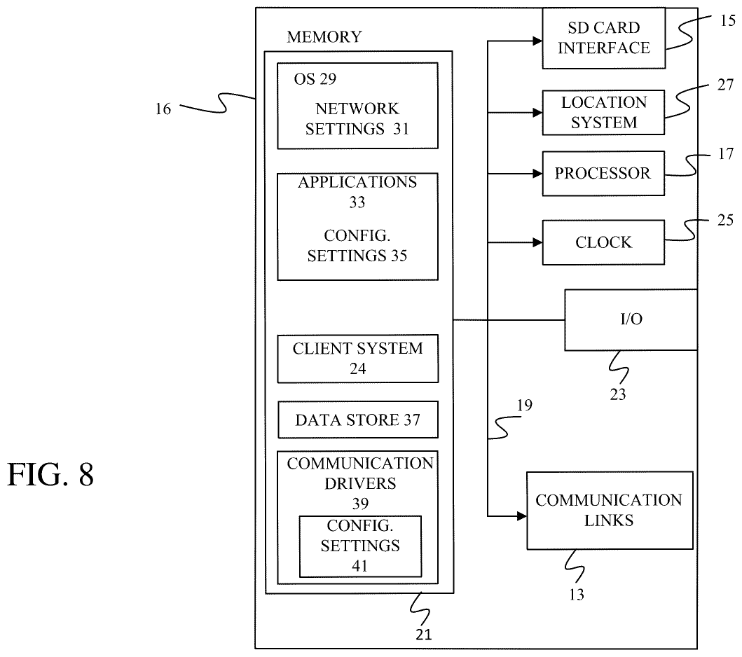

FIG. 8 is a simplified block diagram of one illustrative example of a handheld or mobile computing device that can be used as a user's or client's handheld device 16, in which the present system (or parts of it) can be deployed. For instance, a mobile device can be deployed in the operator compartment of mobile agricultural machine 202 for use in generating, processing, or displaying the adjustment values. FIGS. 8-10 are examples of handheld or mobile devices.

FIG. 8 provides a general block diagram of the components of a client device 16 that can run some components shown in previous FIGS., that interacts with them, or both. In device 16, communications link 13 is provided that allows the handheld device to communicate with other computing devices and under some examples provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors or servers from previous FIGS.) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs the current geographical location of device 16. This can include, for instance, a global positioning system (GPS) receiver, a dead reckoning system, a cellular triangulation system, or other positioning system. Location system 27 can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. Memory 21 can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

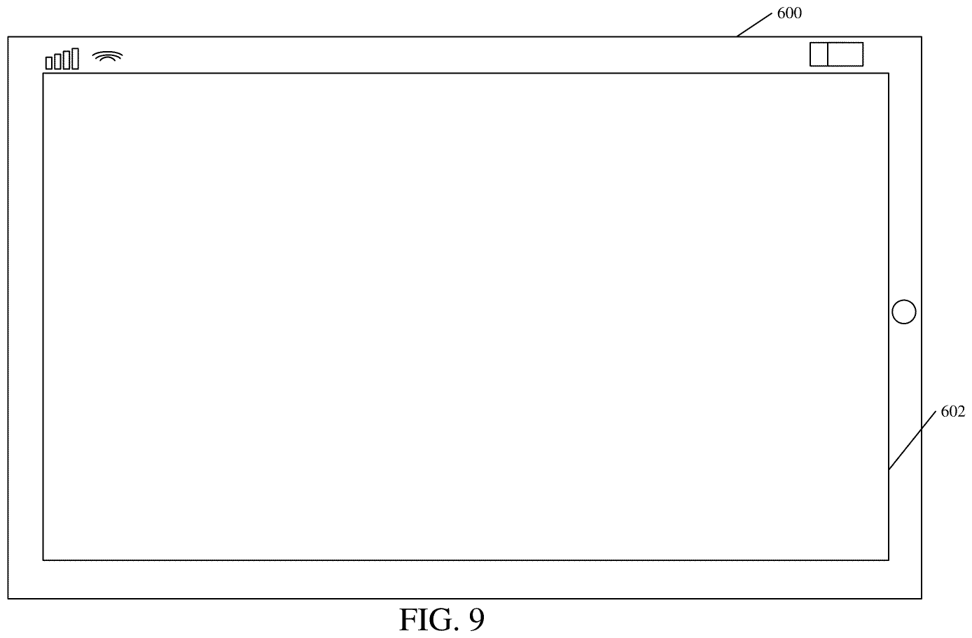

FIG. 9 shows one example in which device 16 is a tablet computer 600. In FIG. 9, computer 600 is shown with user interface display screen 602. Screen 602 can be a touch screen or a pen-enabled interface that receives inputs from a pen or stylus. Computer 600 can also use an on-screen virtual keyboard. Of course, computer 600 might also be attached to a keyboard or other user input device through a suitable attachment mechanism, such as a wireless link or USB port, for instance. Computer 600 can also illustratively receive voice input as well.

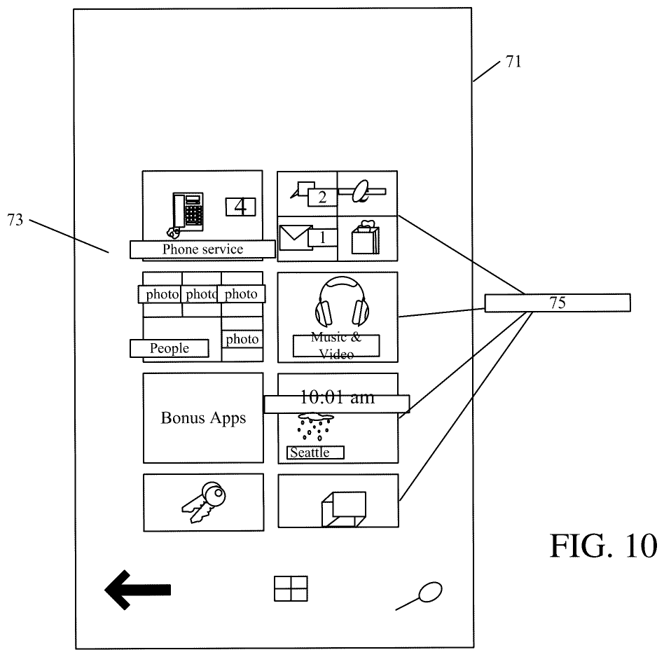

FIG. 10 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of devices 16 are possible.

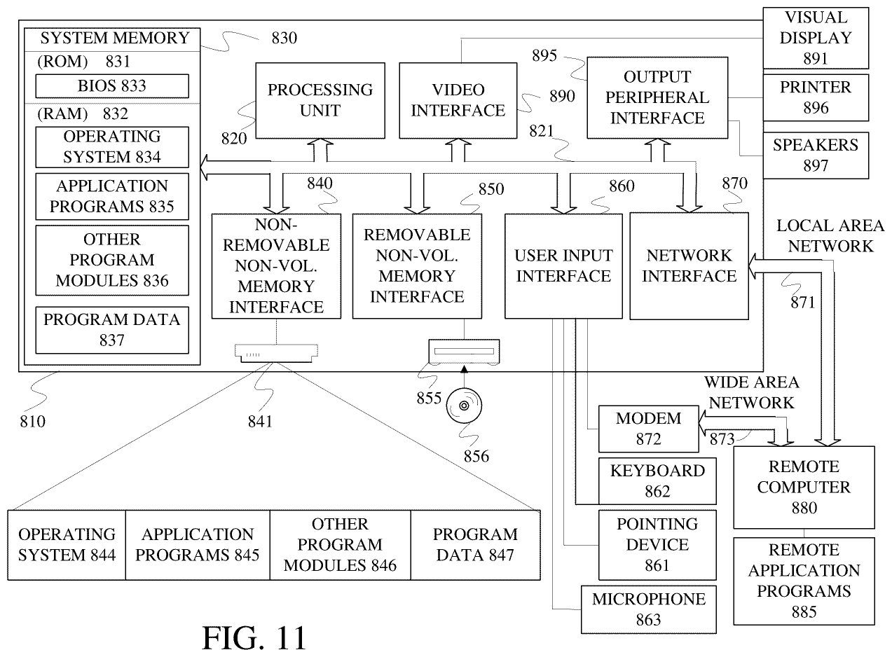

FIG. 11 is one example of a computing environment in which elements of previous FIGS., or parts of it, (for example) can be deployed. With reference to FIG. 11, an example system for implementing some embodiments includes a computing device in the form of a computer 810 programmed to operate as described above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. Memory and programs described with respect to previous FIGS. can be deployed in corresponding portions of FIG. 11.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include a modulated data signal or carrier wave. Computer storage media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 830 includes computer storage media in the form of volatile and/or nonvolatile memory such as read only memory (ROM) 831 and random-access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 11 illustrates operating system 834, application programs 835, other program modules 836, and program data 837.

The computer 810 may also include other removable/non-removable volatile/nonvolatile computer storage media. By way of example only, FIG. 11 illustrates a hard disk drive 841 that reads from or writes to non-removable, nonvolatile magnetic media, an optical disk drive 855, and nonvolatile optical disk 856. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 11, provide storage of computer readable instructions, data structures, program modules and other data for the computer 810. In FIG. 11, for example, hard disk drive 841 is illustrated as storing operating system 844, application programs 845, other program modules 846, and program data 847. Note that these components can either be the same as or different from operating system 834, application programs 835, other program modules 836, and program data 837.

A user may enter commands and information into the computer 810 through input devices such as keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus but may be connected by other interface and bus structures. A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections (such as a controller area network-CAN, local area network-LAN, or wide area network WAN) to one or more remote computers, such as a remote computer 880.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. In a networked environment, program modules may be stored in a remote memory storage device. FIG. 11 illustrates, for example, that remote application programs 885 can reside on remote computer 880.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method for controlling a mobile agricultural machine, comprising:
detecting a target speed of the mobile agricultural machine;
identifying a route ahead of the mobile agricultural machine in a direction of travel;
automatically detecting a pitch change ahead of the mobile agricultural machine along the route; and
automatically adjusting load accommodation functionality based on the target speed of the mobile agricultural machine and based on the pitch change, the load accommodation functionality comprising a gear transmission and a variable speed engine.

2. The computer implemented method of claim 1 wherein automatically adjusting the load accommodation functionality comprises:
automatically adjusting engine speed of the variable speed engine.

3. The computer implemented method of claim 1 wherein automatically adjusting the load accommodation functionality comprises:
automatically adjusting a gear ratio of the gear transmission.

4. The computer implemented method of claim 1 wherein automatically adjusting load accommodation functionality comprises:
computing an adjustment value indicative of a magnitude of adjustment;
computing an adjustment timing based on a location of the pitch change; and
automatically adjusting the load accommodation functionality based on the target speed of the mobile agricultural machine and based on the adjustment value and the adjustment timing.

5. The computer implemented method of claim 1 and further comprising:
identifying a pitch change threshold.

6. The computer implemented method of claim 5 wherein automatically adjusting the load accommodation functionality comprises:
comparing the pitch change to the pitch change threshold to obtain a comparison result; and
automatically adjusting the load accommodation functionality based on the comparison result.

7. The computer implemented method of claim 6 wherein identifying a pitch change threshold comprises:
detecting threshold selection criteria; and
selecting the pitch change threshold, of a plurality of different pitch change thresholds, based on the detected threshold selection criteria.

8. The computer implemented method of claim 1 wherein automatically adjusting the load accommodation functionality comprises:
computing a load change indicative of a change in load on the variable speed engine corresponding to the detected pitch change; and
automatically adjusting the load accommodation functionality based on the load change.

9. The computer implemented method of claim 8 wherein automatically adjusting the load accommodation functionality based on the load change comprises:
computing at least one of a torque or power output of the variable speed engine sufficient to accommodate the load change based on the target speed of the mobile agricultural machine; and
automatically adjusting the load accommodation functionality based on the torque or power output.

10. The computer implemented method of claim 1 wherein detecting the pitch change ahead of the mobile agricultural machine along the route comprises:
accessing georeferenced pitch data corresponding to the route;
detecting a location of the mobile agricultural machine; and
detecting the pitch change ahead of the mobile agricultural machine based on the georeferenced pitch data and the location of the mobile agricultural machine.

11. A mobile agricultural machine, comprising:
a set of ground engaging elements;
load accommodation functionality comprising a variable speed engine and a gear transmission driven by the variable speed engine to drive the set of ground engaging elements at a target speed;
a route identification system configured to identify a route ahead of the mobile agricultural machine in a direction of travel;
a terrain-based load anticipation control system configured to automatically detect a pitch change ahead of the mobile agricultural machine along the route and generate an adjustment value based on the detected pitch change; and
an automated speed control signal generator configured to automatically adjust the load accommodation functionality based on the adjustment value based on the target speed of the mobile agricultural machine as the mobile agricultural machine traverses the pitch change.

12. The mobile agricultural machine of claim 11 wherein the automated speed control signal generator is configured to automatically adjust engine speed of the variable speed engine.

13. The mobile agricultural machine of claim 11 wherein the automated speed control signal generator is configured to automatically adjust a gear ratio of the gear transmission.

14. The mobile agricultural machine of claim 11 wherein the terrain-based load anticipation control system comprises:
a lookahead processing system configured to identify a location of the pitch change along the route
a timing processor configured to compute an adjustment timing based on the location of the pitch change along the route; and
an adjustment output system configured to automatically output the adjustment value and the adjustment timing.

15. The mobile agricultural machine of claim 11 wherein the terrain-based load anticipation control system comprises:
a pitch threshold selector configured to automatically identify a pitch change threshold;
a threshold comparison system configured to compare the pitch change to the pitch change threshold to obtain a comparison result; and
a threshold-based adjustment processor configured to automatically generate the adjustment value based on the comparison result.

16. The mobile agricultural machine of claim 15 and further comprising:
a selection criteria detector configured to detect threshold selection criteria, the pitch threshold selector being configured to select the pitch change threshold, of a plurality of different pitch change thresholds, based on the detected threshold selection criteria.

17. The mobile agricultural machine of claim 11 wherein the terrain-based load anticipation control system comprises:
a load processing system configured to compute a load change indicative of a change in load on the variable speed engine corresponding to the detected pitch change and automatically generate the adjustment value based on the load change.

18. The mobile agricultural machine of claim 17 wherein the load processing system is configured to automatically compute a torque output of the variable speed engine sufficient to accommodate the load change to maintain the target speed of the mobile agricultural machine and automatically generate the adjustment value based on the torque output.

19. The mobile agricultural machine of claim 11 wherein detecting the pitch change ahead of the mobile agricultural machine along the route comprises:
a lookahead window processor configured to access georeferenced pitch data corresponding to the route;
a geographic position sensor configured to detect a location of the mobile agricultural machine; and
a pitch change identification system configured to detect the pitch change ahead of the mobile agricultural machine based on the georeferenced pitch data and the location of the mobile agricultural machine.

20. A control system for controlling a mobile agricultural machine, the control system comprising:
a route identification system configured to identify a route ahead of the mobile agricultural machine in a direction of travel;
a terrain-based load anticipation control system configured to automatically detect a pitch change ahead of the mobile agricultural machine along the route and generate an adjustment value based on the detected pitch change; and
an automated speed control signal generator configured to automatically adjust at least one of an engine speed of a variable speed engine or a gear ratio of a gear transmission driven by the variable speed engine based on the adjustment value based on the target speed of the mobile agricultural machine as the mobile agricultural machine traverses the pitch change.
